(19) United States
(12) Patent Application Publication
(10) Pub. No.: US 2011/0298718 A1
(43) Pub. Date: Dec. 8, 2011

(54) TOUCH-SENSING KEYBOARD

(75) Inventors: Wei-Hong Chang, Taipei County (TW); Robin Lo, Miaoli County (TW); Po-Lun Chen, Hsinchu County (TW)

(73) Assignee: AU OPTRONICS CORPORATION, Hsinchu (TW)

(21) Appl. No.: 12/884,197

(22) Filed: Sep. 17, 2010

(30) Foreign Application Priority Data
Jun. 7, 2010 (TW) 99118396

(51) Int. Cl. G06F 3/02; G06F 3/041

(52) U.S. Cl. 345/168; 345/173

(57) ABSTRACT

A touch-sensing keyboard including a solar cell, a touch panel, and a power converter is provided. The solar cell has a light receiving surface. The touch panel is disposed above the light receiving surface of the solar cell, wherein the solar cell receives light passing through the touch panel and converts the received light into electric power. Furthermore, the power converter is electrically connected to the solar cell and the touch panel, wherein the power converter receives and transforms the electric power generated from the solar cell and outputs the transformed electric power to the touch panel.

### CROSS-REFERENCE TO RELATED APPLICATION

This application claims the priority benefit of Taiwan application serial no. 99118396, filed on Jun. 7, 2010. The entirety of the above-mentioned patent application is hereby incorporated by reference herein and made a part of this specification.

### BACKGROUND OF THE INVENTION

1. Field of the Invention

The present invention relates to a touch-sensing keyboard and more particularly to a touch-sensing keyboard with a self-charging function.

2. Description of Related Art

With the advancement of the computer industry, the mice and the keyboards equipped with the computers become widely used interfaces between humans and machines. Currently, most of the commercialized mice and keyboards are connected to the computer hosts through the connecting lines with particular standards. The connecting lines connected to the computer hosts not only transmit the signals generated by the mice or keyboards to the computer hosts but also transmit the power required in the operations of the mice and the keyboards. Hence, the power of the conventional mice and keyboards are provided by the computer hosts through the connecting lines. With the advancement of the technology, the products such as the wireless mice and the wireless keyboards have been brought to the consumers. It is necessary for these products to be equipped with batteries for providing the power during the operations. However, after the wireless mice and the wireless keyboards are used for a while, the users need to change the batteries, which lead to inconvenience for the users.

### SUMMARY OF THE INVENTION

The present invention provides a touch-sensing keyboard with a self-charging function.

The present invention provides a touch-sensing keyboard comprising a solar cell, a touch panel and a power converter. The solar cell has a light receiving surface. The touch panel is disposed above the light receiving surface of the solar cell. The solar cell receives light passing through the touch panel and converts the received light into electric power. Moreover, the power converter is electrically connected to the solar cell and the touch panel, wherein the power converter receives the electric power from the solar cell and transforms the received electric power, and then outputs the transformed electric power to the touch panel.

According to one embodiment of the present invention, the solar cell includes a monocrystalline silicon solar cell, an amorphous silicon solar cell, a polycrystalline silicon solar cell or a GaAs solar cell.

According to one embodiment of the present invention, the aforementioned solar cell includes a flexible thin film solar cell. The aforementioned flexible thin film solar cell can be, for example, CdS thin film solar cell, CdTe thin film solar cell, CuInSe₂ thin film solar cell, dye sensitized thin film solar cell or organic thin film solar cell.

According to one embodiment of the present invention, the solar cell comprises a front electrode layer, a back electrode layer and a photoelectric converting layer. The front electrode layer is configured over the back electrode layer, and the front electrode layer is configured between the back electrode layer and the touch panel. The photoelectric converting layer is configured between the back electrode layer and the front electrode layer so as to convert the light into the electric power.

According to one embodiment of the present invention, the front electrode layer and the back electrode layer are transparent electrode layers.

According to one embodiment of the present invention, the front electrode layer is a transparent electrode layer and the back electrode layer is a reflective electrode layer.

According to one embodiment of the present invention, the touch panel includes a resistive touch panel, a capacitive touch panel, an optical touch panel or an acoustic-wave touch panel.

According to one embodiment of the present invention, the touch-sensing keyboard further comprises a keyboard-signal transmission interface electrically connected to the touch panel. Accordingly, the keyboard-signal transmission interface includes a signal transmission wiring or a wireless signal transmission module.

According to one embodiment of the present invention, the touch-sensing keyboard further comprises a transparent electromagnetic interference shielding layer configured between the solar cell and the touch panel.

Accordingly, the touch-sensing keyboard of the present invention has the built-in solar cell and the built-in power converter so that the touch-sensing keyboard of the present invention has self-charging function providing the electric power necessary for the operation of the touch-sensing keyboard. The touch-sensing keyboard utilizes the solar cell to provide the electric power necessary for the operation of the touch-sensing keyboard, so as to reduce power consumption.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a touch-sensing keyboard according to the present invention.

FIG. 2 is a schematic view of a touch-sensing keyboard according to one embodiment of the present invention.

FIG. 3 is a schematic view of a touch-sensing keyboard according to another embodiment of the present invention.

### DESCRIPTION OF EMBODIMENTS

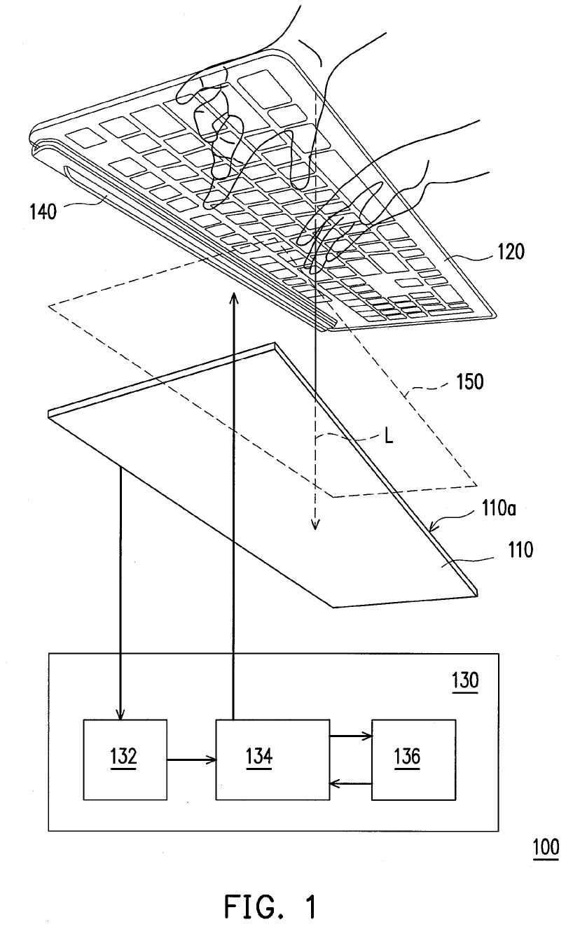

FIG. 1 is a schematic view of a touch-sensing keyboard according to the present invention. As shown in FIG. 1, a touch-sensing keyboard 100 of the present embodiment comprises a solar cell 110, a touch panel 120 and a power converter 130. The solar cell 110 has a light receiving surface 110a. The touch panel 120 is disposed above the light receiving surface 110a of the solar cell 110. The solar cell 110 receives light L passing through the touch panel 120 and converts the received light L into electric power. Moreover, the power converter 130 is electrically connected to the solar cell 110 and the touch panel 120. The power converter 130 receives the electric power from the solar cell 110 and transforms the electric power, and then outputs the transformed electric power to the touch panel 120.

In the present embodiment, the solar cell 110 can be, for example, a monocrystalline silicon solar cell, an amorphous silicon solar cell, a polycrystalline silicon solar cell, a GaAs solar cell or the solar cells made of other materials. In addition, the solar cell 110 can also be a flexible thin film solar cell. For instance, the aforementioned flexible thin film solar cell can be, for example, CdS thin film solar cell, CdTe thin film solar cell, CuInSe₂ thin film solar cell, dye sensitized thin film solar cell, organic thin film solar cell or the thin film solar cells made of other materials.

It should be noticed that, in the present embodiment, the key patterns of the keyboard can be formed on the touch panel 120 by the printing process or the etching process in advance so that the users can recognize meanings of the touch-sensing regions. Off course, in the present embodiment, the key patterns of the keyboard can be projected onto the touch panel 120 by the optical projection process so that the users can recognize meanings of the touch-sensing regions. In order to make the touch panel 120 to transmit the signals to the computer host, the touch panel 120 can further comprises a keyboard-signal transmission interface 140 which is connected to the touch panel 120 and is used as the communication interface between the touch panel 120 and the computer host. Accordingly, the keyboard-signal transmission interface 140 can be, for example, a signal transmission wiring or a wireless signal transmission module.

In the present embodiment, the touch panel 120 can be, for example, a resistive touch panel, a capacitive touch panel, an optical touch panel, an acoustic-wave touch panel or other types of touch panels. It should be noticed that the touch panel 120 should be as transmissible as possible for the light L so that the solar cell 110 can transform a mass of light L into the electric power necessary for the operation of the touch-sensing keyboard 100. Since the user often operates the touch-sensing keyboard 100 in an environment with lights, the touch-sensing keyboard 100 having the self-charging function is capable of effectively decreasing the power consumption.

When the solar cell 110 and the touch panel 120 are both flexible, the touch-sensing keyboard 100 of the present embodiment becomes a flexible keyboard so that it is more convenient for the user to store and carry the touch-sensing keyboard 100.

As shown in FIG. 1, the power converter 130 of the present embodiment comprises a charge controlling unit 132, a power converting unit 134 and a electric power storing unit 136. As shown in FIG. 1, the charge controlling unit 132 is electrically connected to the solar cell 110 so that the charge controlling unit 132 transmits the electric power generated by the solar cell 110 to the power converting unit 134. The electric power processed by the power converting unit 134 is transmitted to and stored in the electric power storing unit 136. In the present embodiment, the power converting unit 134 can convert the electric power generated by the solar cell 110 into the electric power (e.g. the signal having a particular voltage level) suitable for driving the touch panel 120. When the touch-sensing keyboard 100 is not used by the user, the electric power is transmitted to and stored in the electric power storing unit 136 after the electric power generated by the solar cell 110 is processed by the power converting unit 134. On the other hand, when the touch-sensing keyboard 100 is used by the user, the power converting unit 134 can directly provide the electric power generated by the solar cell 110 to the touch panel 120. Off course, the power converting unit 134 can also get the power directly from the electric power storing unit 136 and provides it to the touch panel 120.

The solar cell transforms the light L into the electric power along with the electromagnetic waves and the electromagnetic waves affect the operations of the other electronic devices. For instance, the touch panel 120 can be affected by the electromagnetic waves generated by the solar cell 110. In order to prevent the touch panel 120 from the aforementioned problem, the touch-sensing keyboard 100 of the present embodiment further comprises a transparent electromagnetic interference shielding layer 150 configured between the solar cell 110 and the touch panel 120. It is should be noticed that the transparent electromagnetic interference shielding layer 150 is made of transparent conductive material, such as Indium Tin Oxide (ITO) or Indium Zinc Oxide (IZO).

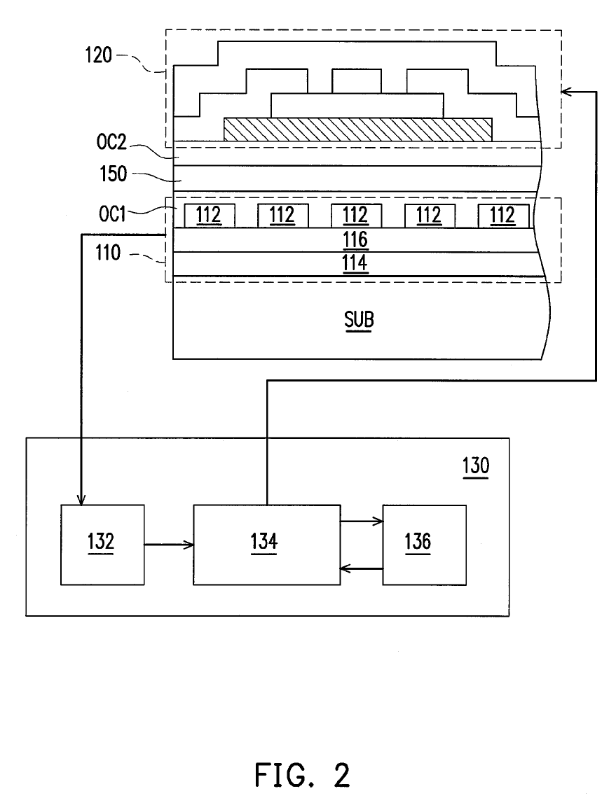

FIG. 2 is a schematic view of a touch-sensing keyboard according to one embodiment of the present invention. As shown in FIG. 2, the solar cell 110 of the present embodiment comprises a front electrode layer 112, a back electrode layer 114 and an photoelectric converting layer 116. The front electrode layer 112 is configured over the back electrode layer 114, and the front electrode layer 112 is configured between the back electrode layer 114 and the touch panel 120. The photoelectric converting layer 116 is configured between the back electrode layer 114 and the front electrode layer 112 so as to convert the light into the electric power. It should be noticed that, in FIG. 2, the solar cell 110 is fabricated on a substrate SUB and the touch panel 120 is fabricated on the solar cell 110. Specifically, in order to manufacture the solar cell 110 on the touch panel 120, a dielectric layer OC1 can be formed on the front electrode layer 112 and the photoelectric converting layer 116 and then the transparent electromagnetic interference shielding layer 150 and a dielectric layer OC2 are formed on the dielectric layer OC1 in sequence. Thereafter, the touch panel 120 is formed on the dielectric layer OC2. Since the touch panel 120 is formed on the solar cell 110, the thickness and the weight of the touch-sensing keyboard shown in FIG. 2 can be further decreased.

Moreover, the front electrode layer 112 and the back electrode layer 114 of the present embodiment can be, for example, transparent electrode layers. In other embodiments, the front electrode layer 112 can be, for example, a transparent electrode layer and the back electrode layer 114 can be, for example, a reflective electrode layer.

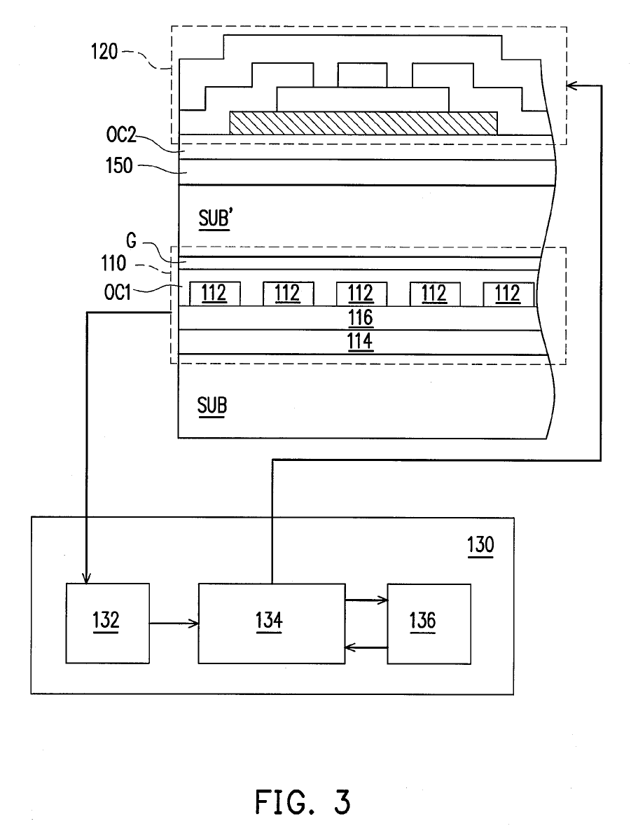

FIG. 3 is a schematic view of a touch-sensing keyboard according to another embodiment of the present invention. As shown in FIG. 2 and FIG. 3, the touch-sensing keyboards respectively in FIG. 3 and FIG. 2 are similar to each other and the difference therebetween is the touch panel 120 in the touch-sensing keyboard shown in FIG. 3 is manufactured on another substrate SUB′. Specifically, the solar cell 110 is formed on the substrate SUB and the touch panel 120 is formed on the substrate SUB′. Further, the substrate SUB′ having the touch panel 120 thereon, for example but not limited to, can be configured on the solar cell 110 by attaching process with the use of an adhesion layer G.

Accordingly, the touch-sensing keyboard of the present invention has the built-in solar cell and the built-in power converter so that the touch-sensing keyboard of the present invention has self-charging function providing the electric power necessary for the operation of the touch-sensing keyboard. The touch-sensing keyboard utilizes the solar cell to provide the electric power necessary for the operation of the touch-sensing keyboard, so as to reduce power consumption.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A touch-sensing keyboard, comprising:
a solar cell having a light receiving surface;
a touch panel configured over the light receiving surface of the solar cell, wherein the solar cell receives a light passing through the touch panel and transforms the received light into an electric power; and
a power converter electrically connected to the solar cell and the touch panel, wherein the power converter receives the electric power from the solar cell and transforms the received electric power, and outputs the transformed electric power to the touch panel.

2. The touch-sensing keyboard of claim 1, wherein the solar cell includes a monocrystalline silicon solar cell, an amorphous silicon solar cell, a polycrystalline silicon solar cell or a GaAs solar cell.

3. The touch-sensing keyboard of claim 1, wherein the solar cell includes a flexible thin film solar cell.

4. The touch-sensing keyboard of claim 4, wherein the solar cell includes CdS thin film solar cell, CdTe thin film solar cell, CuInSe₂ thin film solar cell, dye sensitized thin film solar cell or organic thin film solar cell.

5. The touch-sensing keyboard of claim 1, wherein the solar cell comprises:
a back electrode layer;
a front electrode layer configured over the back electrode layer, wherein the front electrode layer configured between the back electrode layer and the touch panel; and
a photoelectric converting layer configured between the back electrode layer and the front electrode layer to covert the light into the electric power.

6. The touch-sensing keyboard of claim 1, wherein the front electrode layer and the back electrode layer are transparent electrode layers.

7. The touch-sensing keyboard of claim 1, wherein the front electrode layer is a transparent electrode layer and the back electrode layer is a reflective electrode layer.

8. The touch-sensing keyboard of claim 1, wherein the touch panel includes a resistive touch panel, a capacitive touch panel, an optical touch panel or an acoustic-wave touch panel.

9. The touch-sensing keyboard of claim 1, further comprising a keyboard-signal transmission interface electrically connected to the touch panel.

10. The touch-sensing keyboard of claim 9, wherein the keyboard-signal transmission interface includes a signal transmission wiring or a wireless signal transmission module.

11. The touch-sensing keyboard of claim 1, further comprising a transparent electromagnetic interference shielding layer configured between the solar cell and the touch panel.
